(19) United States
(12) Patent Application Publication
(10) Pub. No.: US 2004/0128627 A1
(43) Pub. Date: Jul. 1, 2004

(54) Methods implementing multiple interfaces for a storage device using a single ASIC

(76) Inventor: Fernando A. Zayas, Loveland, CO (US)

Correspondence Address: FLIESLER MEYER, LLP, FOUR EMBARCADERO CENTER, SUITE 400, SAN FRANCISCO, CA, 94111, US

(21) Appl. No.: 10/419,540

(22) Filed: Apr. 21, 2003

Related U.S. Application Data
(60) Provisional application No. 60/436,742, filed on Dec. 27, 2002.
(60) Provisional application No. 60/436,674, filed on Dec. 27, 2002.

(51) Int. Cl. G06F 17/50

(52) U.S. Cl. 716/1

(57) ABSTRACT

Methods for producing and using a single application specific integrated circuit (ASIC) die, to support multiple interfaces for rotating media storage devices, are provided. At least two different interfaces for storage devices including rotatable storage medium are compared. Elements that are common to the different interfaces are identified. Elements that are unique to the different interfaces are also identified. The unique elements for each of the different interfaces, and the common elements, are incorporated into a single ASIC die. Switching is implemented within the single ASIC die, such that the common elements are used regardless of which one of the different interfaces is being used, and the unique elements are used based on which one of the different interfaces is being used.

### PRIORITY CLAIM

This application claims priority to U.S. Provisional Patent Application No. 60/436,742, entitled “Storage Device Implementing Multiple Interfaces Using a Single ASIC” and U.S. Provisional Patent Application No. 60/436,674, entitled “Methods Implementing Multiple Interfaces for a Storage Device Using a Single ASIC,” both of which were filed on Dec. 27, 2002.

### Related Application

This application is related to commonly invented and commonly assigned U.S. patent application Ser. No. ______ (Attorney Docket No. PANA-01047US2), entitled “Storage Device Implementing Multiple Interfaces Using a Single ASIC,” which was filed the same day as the present application.

### FIELD OF THE INVENTION

The present invention relates to storage devices that include a rotatable medium, and more particularly to the interfaces for such storage devices.

### BACKGROUND

Storage devices, such as hard disk drives and optical drives (e.g., CD or DVD drives) include a rotatable medium (e.g., a disk) upon which data can be stored. Typically host computers write data to or read data from such storage devices. Interfaces are required to enable the host computers to communicate with the storage devices. The term interface, as used herein, is generally used to refer to the physical and electrical connections and the protocol that a storage device uses to communicate with another device (e.g., a host computer).

Conventionally, each storage device is uniquely designed to operate using only a single type of interface. For example, an interface included in an ATA (Advanced Technology Architecture) hard drive of 10 GB capacity is different than an interface included in a SCSI (Small Computer Systems Interface) hard drive of 9 GB capacity. The physical connectors are different. The electrical signals used to communicate are different. And further, the ASIC (Application Specific Integrated Circuit) that provides ATA interface functionality (e.g., electrical signaling and protocol implementation), is different than the ASIC that provides SCSI interface functionality. The various physical connectors required for different interfaces are generally available off the shelf, and thus, producing different storage devices requiring different physical connectors does not significantly increase the cost of producing the different storage devices. On the other hand, the costs associated with developing and stocking multiple different ASICs is very high. Once an ASIC is developed, economies of scale cause the cost of manufacturing of multiple identical ASICs to be fairly low. More specifically, the greater the number of identical ASICs manufactured, the lower the cost of each ASIC. Accordingly, it would be beneficial to reduce the costs associated with developing and stocking multiple different ASICs. Further, it would be beneficial to take advantage of economies of scale to reduce the costs of ASICs.

### DESCRIPTION OF DRAWINGS

FIG. 1 is a block diagram illustrating how different storage devices require different ASICs;

FIG. 2 is a block diagram illustrating how a common ASIC die, according to embodiments of the present invention, can be included in different storage devices;

FIG. 3 is a flow diagram illustrating a method for producing a common ASIC die, according to an embodiment of the present invention;

FIG. 4A is a high level block diagram illustrating a common ASIC die, according to an embodiment of the present invention;

FIG. 4B is a block diagram showing some additional details of the common ASIC die of FIG. 4A, according to an embodiment of the present invention;

FIG. 5 is a high level block diagram illustrating a common ASIC die, according to another embodiment of the present invention; and

FIG. 6 is a high level diagram of an exemplary disk drive storage device, in which embodiments of the present invention are useful.

### DESCRIPTION OF THE PRESENT INVENTION

Storage device interfaces have been generally moving away from the old parallel interfaces, such as SCSI and earlier versions of ATA, and are becoming generally serial interfaces, such as Fibre Channel, Serial ATA, and Gigabit Ethernet. The inventor of the present invention has recognized that while being developed, new interface standards have often borrowed from earlier interface standards. This has significantly reduced the time and cost for developing the new interfaces. For example, when Fibre Channel was being developed, some of the coding was borrowed from old IBM block multiplexer channels. In turn, Gigabit Ethernet borrowed from Fibre Channel. Similarly, serial ATA borrowed elements (e.g., transceivers and 8-bit encoding) from previous interfaces. As will be explained in more detail below, the inventor of the present invention has appreciated that the commonality between such interfaces can be used to produce a single interface ASIC that can be used with different interfaces.

Embodiments of the present invention provide an ASIC die that can be used in different storage devices to support multiple different interfaces. Exemplary interfaces include serial ATA, Fibre Channel, and Gigabit Ethernet.

An embodiment of the present invention is directed to a method for producing such an ASIC die. Embodiments of the present invention are also related to ASIC dies, and ASIC packages that package ASIC dies. Embodiments of the present invention are also directed to PCBAs and storage devices that include ASIC dies or ASIC packages produced in accordance with the present invention.

A method for producing an ASIC die, according to an embodiment of the present invention, begins by comparing at least two different interfaces. Elements that are common to the different interfaces are identified. Elements that are unique to the different interfaces are also identified. The unique elements for each of the different interfaces, and the common elements, are then incorporated into a single ASIC die. Switching within the single ASIC die is implemented, such that the common elements are used regardless of which of the different interfaces is being used, and the unique elements are used based on which one of the different interfaces is being used. For example, of first subset of the unique elements are used (e.g., enabled and/or included in a data path) if a first interface is being used (e.g., supported), and a second subset of the unique elements are used if the second interface is being used. Switches within the single ASIC die are provided to connect the common elements to elements that are unique to the different interfaces.

In accordance with an embodiment of the present invention, a signal is monitored to determine which one of the different interfaces is being used. Alternatively, or additionally, the specific interface being used is determined based on which ones of a plurality of terminals are electrically connected together (e.g., using a jumper(s)).

An embodiment of the present invention is directed to a common ASIC die capable of supporting a first interface and a second interface. The ASIC die includes elements that are common to both the first interface and the second interface. The ASIC die also includes elements that are unique to the first interface, and elements that are unique to the second interface. A plurality of switches and a controller are also included in the ASIC die. The controller is adapted to control the switches such that the common elements are used regardless of which of the two interfaces is being used, and the unique elements are used based on which one of the two interfaces is being used. More specifically, in accordance with an embodiment of the present invention, the elements that are unique to the first interface are used if the first interface is being used, and the elements that are unique to the second interface are used if the second interface is being used.

The controller can determine which of the two interface is being used in various ways. For example, the controller can monitor a signal to determine which one of the two interfaces is being used. The controller can alternatively, or additionally, access a memory to determine which one of the two interfaces is being used. The controller may alternatively, or additionally, make the determination based on which one(s) of a plurality of terminals (e.g., pins, balls, pads, etc.) are electrically connected together.

In accordance with another embodiment of the present invention, a common ASIC supports more than two different interfaces.

Further embodiments, and the features, aspects, and advantages of the present invention will become more apparent from the additional description set forth below, the drawings and the claims.

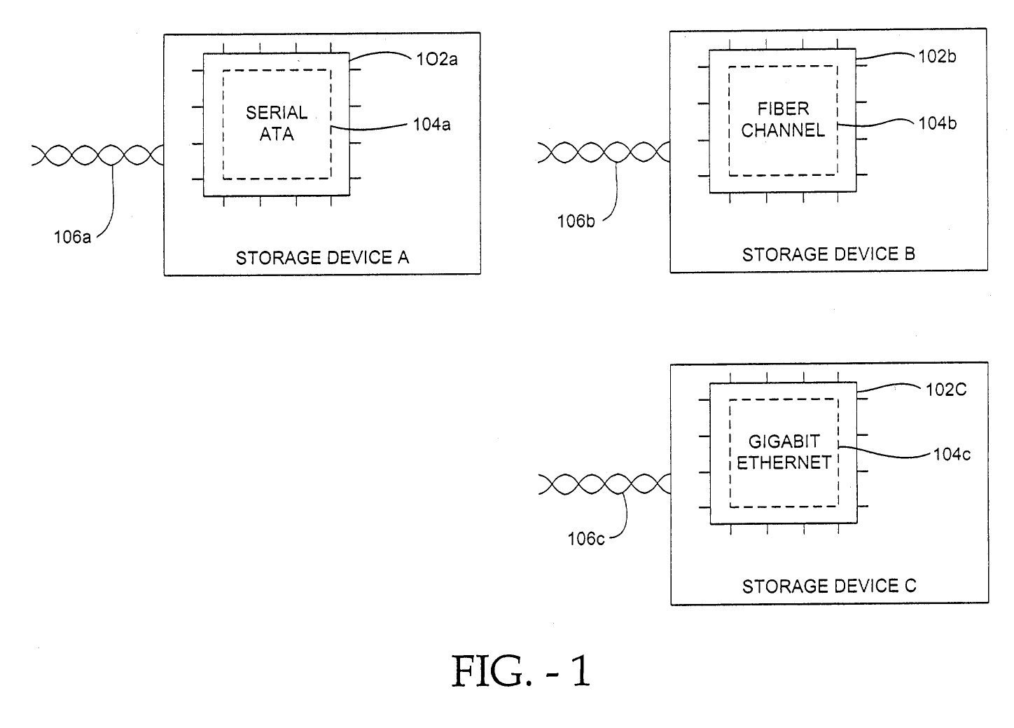

FIG. 1 is a block diagram illustrating how different storage devices have required different interface ASICs. Three different storage devices are shown, where except for the interface ASIC, each store device is substantially identical to one other. Storage device A is shown as including an ASIC package 102a that houses an ASIC die 104a specifically designed to implement a serial ATA interface. ASIC package 102a is attached to a printed circuit board assembly (PCBA) within storage device A. A physical connection 106a (e.g., including a cable and end connector(s)) connects the PCBA to a host (directly, or more likely through one or more system busses) that supports Serial ATA. Storage device B is shown as including an ASIC package 102b that houses an ASIC die 104b specifically designed to implement a Fibre Channel interface. ASIC package 102b is attached to a PCBA within storage device B. A physical connection 106b connects the PCBA to a host that supports Fibre Channel. Finally, storage device C is shown as including an ASIC package 102c that houses an ASIC die 104c specifically designed to implement a Gigabit Ethernet interface. ASIC package 102c is attached to a PCBA within storage device C. A physical connection 106c connects the PCBA to a host that supports Gigabit Ethernet. Other than the ASICs, the PCBAs within each of the different storage devices are substantially the same (i.e., identical or at least substantially identical).

Each of these three storage devices (or at least, each of the PCBAs) are likely designed and/or manufactured by the same company. However, the three different interfaces maybe necessary due to the different demands of customers. Accordingly, even though a majority of each storage device is substantially the same (e.g., the servo system, the flash memory, the actuator assembly, etc.), a significant amount of effort (including time, money and man power) is spent designing the different interfaces. For example, a first group of engineers may design the serial ATA interface ASIC die 104a, a second group of engineers may design the Fibre Channel interface ASIC die 104b, and a third group of engineers may design the Gigabit Ethernet interface ASIC die 104c. Additionally, once the three distinct ASIC dies are designed, there is the requirement to prototype, test, manufacture and stock each of the three separate ASIC dies. As will be explained below, embodiments of the present invention overcome many of these disadvantages.

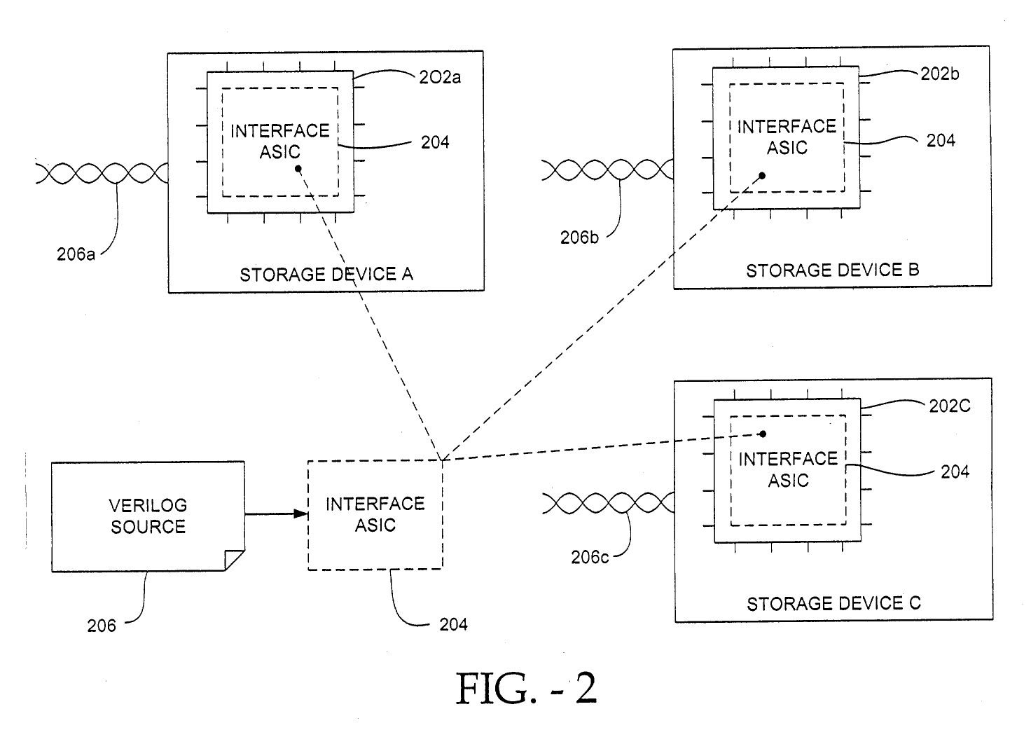

FIG. 2 is a block diagram illustrating the sharing of a common ASIC die 204, in accordance with embodiments of the present invention. Three different storage devices are shown, where except for the interface ASIC, each of the store devices are substantially the same (i.e., identical or at least substantially identical). A first physical connection 206a connects Storage Device A to a host that supports serial ATA (e.g., the host has a serial ATA interface card connected to its mother board). A second physical connection 206b connects Storage Device B to a host that supports Fibre Channel. Finally, a third physical connection 206c connects Storage Device C to a host that supports Gigabit Ethernet.

The common ASIC dies 204 are generated using a common HDL (Hardware Description Language) source, e.g., a common Verilog source 206 or a VHDL source. Each ASIC die 204 may be packaged in a different package or in a common package. In other words, even though ASIC dies 204 are all the same, ASIC packages 202a, 202b and 202c may differ from one another. However, preferably the ASIC packages 202a, 202b and 202c are also all the same.

In accordance with embodiments of the present invention, the same interface ASIC 204 (and preferably the same ASIC package 202) is used regardless of whether the storage device will connect to a host supporting a serial ATA interface, a Fibre Channel interface, or a Gigabit Ethernet interface. Thus, only a single ASIC die 204 needs to be designed, prototype, tested, mass produced and stocked. This will consume substantially less resources than is required to design, prototype, test, mass produce and stock three different ASIC dies (as is conventionally necessary). Further, because only a single ASIC die 204 is being mass produced, economies of scale will further lower the cost of each unit.

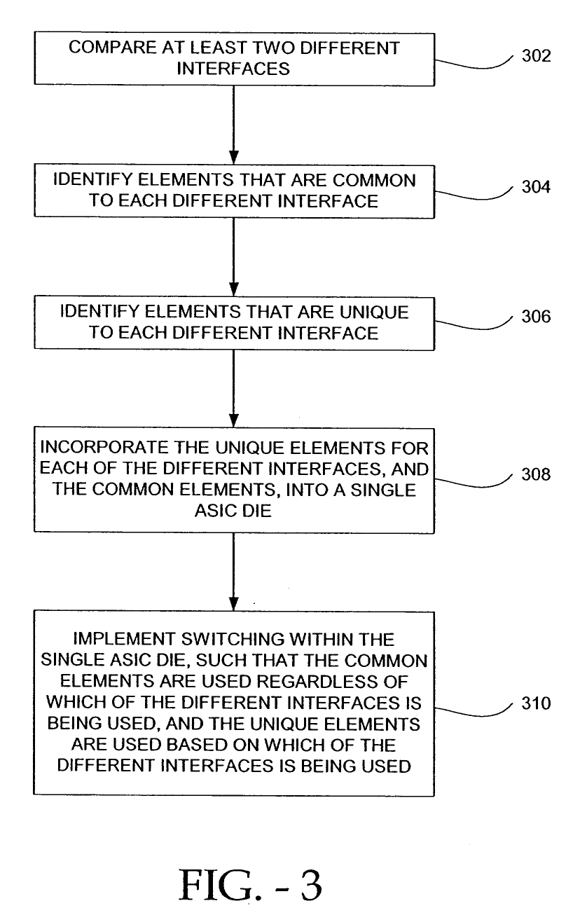

FIG. 3 is a high level flow diagram of a method 300, according to an embodiment of the present invention, that can be used to produce common ASIC die 204. In a first step 302, a comparison between at least two different interfaces is performed. For example, a comparison between serial ATA, Fibre Channel and/or Gigabit Ethernet may be performed. Such a comparison can be performed, for example, manually, by computers, or by combinations thereof. A step 304 involves identifying elements that are common to the different interfaces. For example, the receivers, transmitters, coders and/or decoders (or portions thereof) within the different interfaces, can be substantially the same. Additionally, at a step 306, elements that are unique to each different interface is identified. One of ordinary skill in the art will appreciate that steps 302, 304 and 306 can be performed simultaneously, or that the specific order of these steps can be altered.

At a step 308, the unique elements for each of the different interfaces, and the common elements, are incorporated into a single ASIC die (e.g., die 204). Additionally, at a step 310, switching within the single die (e.g., die 204) is implemented such that the common elements are used regardless of which of the different interfaces (e.g., serial ATA, Fibre Channel or Gigabit Ethernet) is being used, and the unique elements are used based on which of the different interfaces is being used. For example, assume a first interface and a second interface share a common receiver, but require different coders. The common ASIC would include the common receiver along with the two unique coders. Then, depending on which interface is being used, appropriate switching occurs within the ASIC so that the common receiver and the appropriate one of the two coders is used. One of ordinary skill in the art will appreciate that steps 308 and 310 can be performed simultaneously, or that the specific order of these steps can be changed.

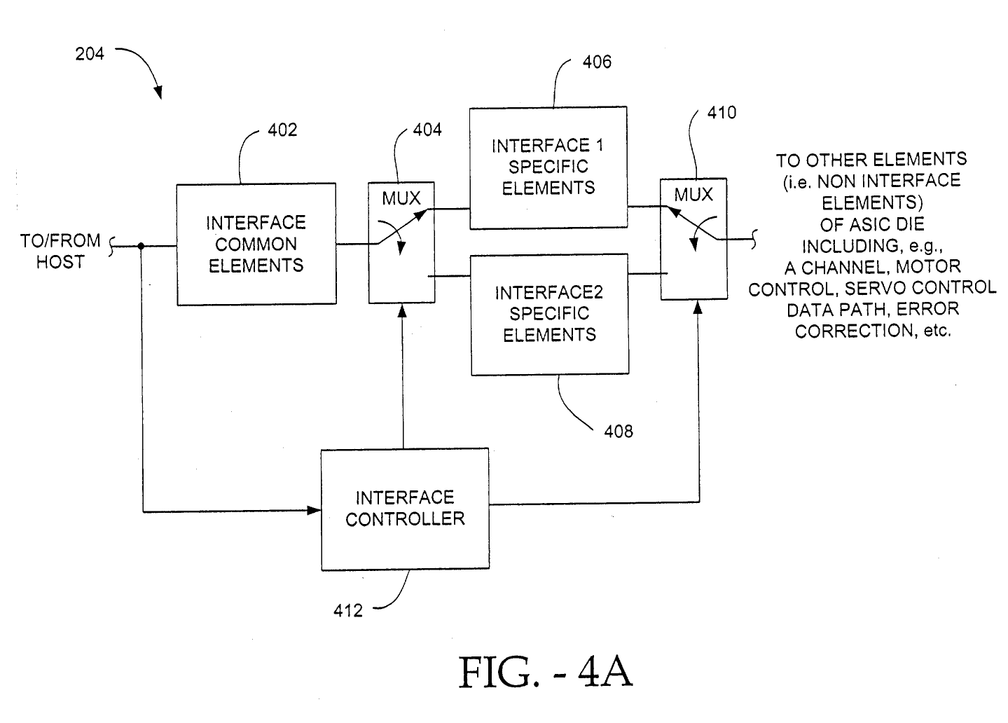

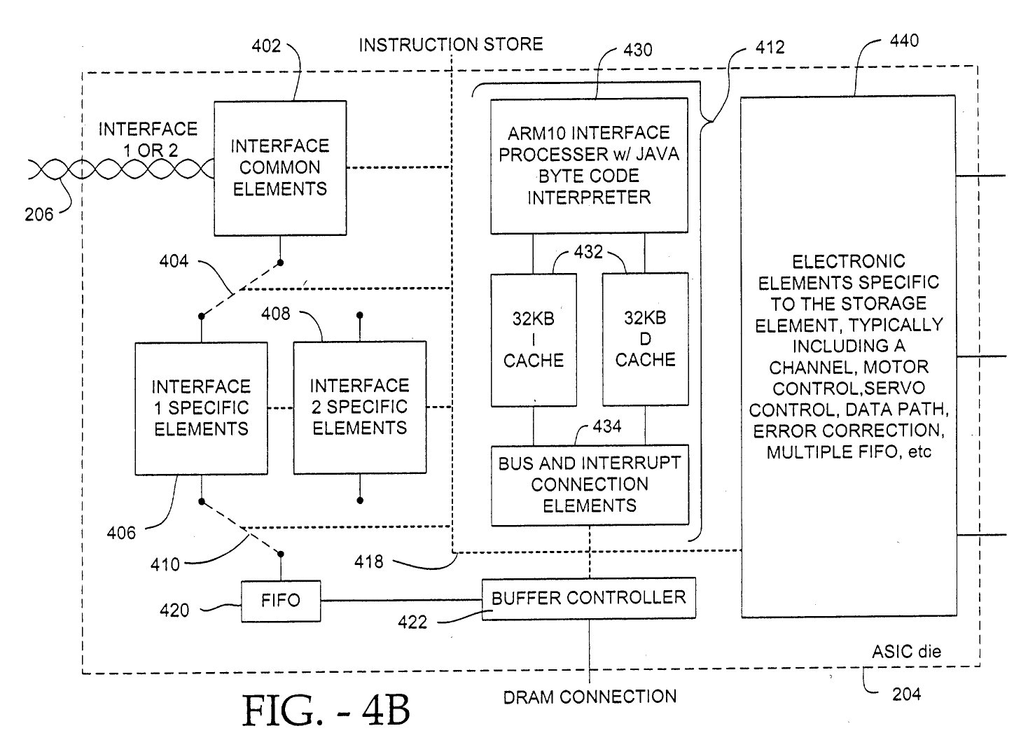

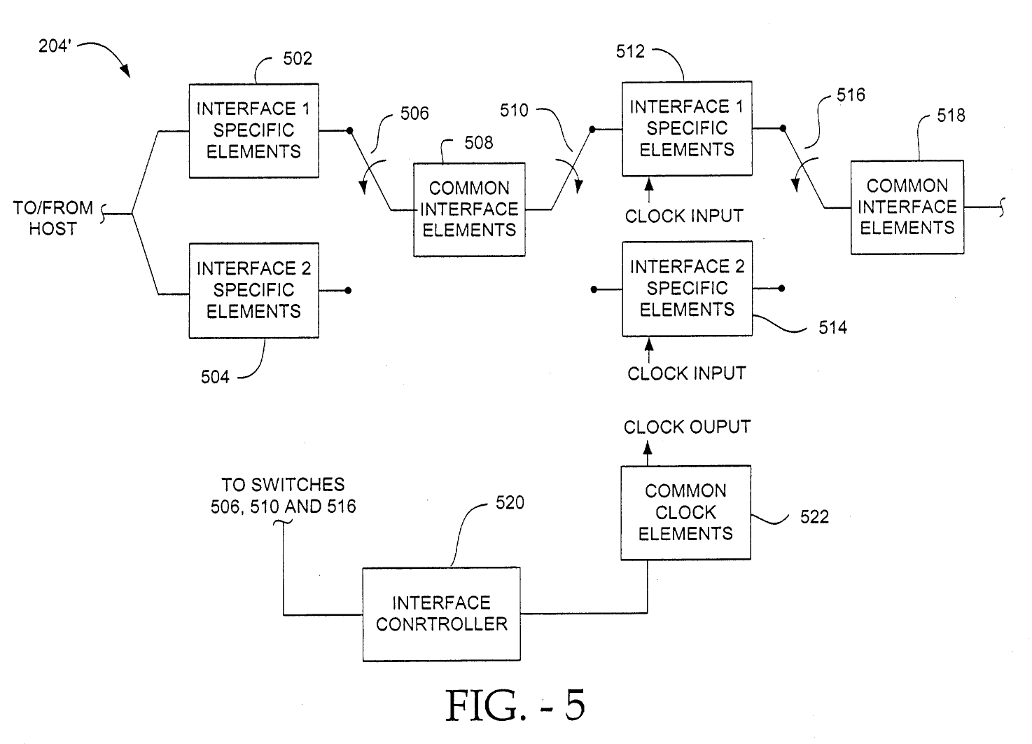

Method 300 takes advantage of the commonality that has resulted from interfaces borrowing from other interfaces. FIGS. 4A, 4B and 5 will now be used to illustrate exemplary common ASIC dies.

FIG. 4A is a high level block diagram that is useful for illustrating common interface ASIC die 204, according to an embodiment of the present invention. In this example, common interface ASIC die 204 can support a first interface (e.g., serial ATA) or a second interface (e.g., Fibre Channel). The elements that are common to both the first interface and the second interface are graphically represented by block 402. The elements that are unique to the first interface are represented by block 406. The elements that are unique to the second interface are represented by block 408. Switches within the ASIC are represented as multiplexors 404 and 410, but can be implemented using any type of switch (e.g., transistors). An interface controller is represented by block 412.

In accordance with an embodiment of the present invention, interface controller 412 monitors signals that are received (e.g., from a host), and determines which one of the multiple interfaces is being used based on the received signals. For example, interface controller 412 can detect a specific wake-up signal (or some other low-level or out-of-band signaling) that is only used with the first interface, and then implement switching within ASIC 204 such that first interface specific elements 406 are used with comment elements 404, to support the interface. The speed of interface controller 412 is specified by a clock implemented within ASIC 204, or possibly, external to ASIC 204. Power consumption is generally a linear function of clock rate. In accordance with an embodiment of the present invention, while interface controller 412 is in a semi-dormant state (e.g., because the host is not attempting to communicate with interface ASIC 204), interface controller 412 polls a serial line from the host at a reduced clock rate (as compared to the rate while in normal operation) to conserve power. For example, if interface controller normally runs at 300 MHz, it may run at only 30 MHz while polling. Interface controller 412 may perform all the functionality necessary to monitor (including poll) one or more received signals. Alternatively, or additionally, interface controller 412 may communicate with hardware and/or software external to ASIC 204, which assists interface controller 412 with the monitoring.

In accordance with an alternative embodiment of the present invention, the type of interface to be used (e.g., serial ATA, Fibre Channel, or Gigabit Ethernet) can be specified and stored in non-volatile memory in the storage drive (e.g., ROM, flash or media). The interface controller 412 can determine which interface to implement based on which interface is specified in the non-volatile memory. For example, interface controller 412 may access a predetermined register to learn which interface is being used.

In accordance with another embodiment of the present invention, the type of interface being used can be specified by a jumper (e.g., a metal bridge that closes an electrical circuit). For example, an ASIC die can be designed such that: connecting a pair of terminals (e.g., pins, balls, pads, etc.) of the ASIC package will cause interface controller 412 to implement a first interface; and connecting a different pair of terminals of the ASIC package will cause interface controller 412 to implement a second interface. Such a bridge can be implemented using a wire, a conductive path on the PCBA, or the like. Of course, more than a pair of terminals may be connected to specify an interface.

FIG. 4B is a block diagram showing some additional details of the common ASIC die 204 of FIG. 4A, according to an embodiment of the present invention. In this embodiment, interface controller 412 includes an ARM 10 (Advanced RISC Machine) processor (available from ARM Ltd., Cambridge, England), which has a Java byte code interpreter. By including a Java byte code interpreter within the ASIC die 204, a storage device can receive applets from the host. Such applets can instruct the storage device to perform specific functions and/or to update specific functionality. Interface controller 412 also includes a pair of caches 432 and a bus and interrupt connection elements block 434. Interface controller 412 communicates with various other elements within ASIC 204, including switches, via a bus 418. Using bus 418, interface controller 412 configures switches 404 and 410 to connect the interface specific elements (406 or 408) to the rest of ASIC die 204 through a data path that includes a buffer 420 and a buffer controller 422. Other storage device elements, such as a channel, motor control, servo control, etc., to which a data path may terminate (or initiate) are represented by block 440.

In the block diagram of FIGS. 4A and 4B, the common interface elements are shown as being grouped together (in block 402), as are the interface specific elements (in blocks 406 and 408). Further, only two switches (404 and 410) are shown for switching between the interface specific elements. However, it is likely that the common interface elements and the unique elements will not be grouped so nicely together. Rather, it is more likely that the interface specific elements, as well as the common elements, will be distributed throughout the ASIC, requiring much more than two switches. This is shown by way of example in FIG. 5.

FIG. 5 is a high level block diagram that is useful for illustrating a common interface ASIC die 204′, according to an embodiment of the present invention, that can support a first interface (e.g., serial ATA) or a second interface (e.g., Fibre Channel). The elements that are common to both the first interface and the second interface are graphically represented by blocks 508, 518 and 522. The elements that are unique to the first interface are represented by blocks 502 and 512. The elements that are unique to the second interface are represented by blocks 504 and 514. Switches within the ASIC include switches 506, 510 and 516. An interface controller, represented by block 520, controls switches 506, 510 and 516. Interface controller 520 also controls the frequency of common clock element 522, wherein the appropriate frequency is selected based upon which of the first and second interfaces is being used.

In an alternative embodiment, the common clock element may drive one or more divide-by or multiply-by circuits. In such an embodiment, interface controller 520 can select which clock output (e.g., the output of a divide-by four circuit) should be used to drive other circuitry within the ASIC, based upon which interface is being used.

As discussed above, common interface elements and unique (i.e., specific) interface elements can be receivers, transmitters, coders, decoders, or the like (or portions thereof). However, common interface elements and unique interface elements can also be much lower level elements, such as resistors, capacitors, and the like. For example, a significant portion of a receiver can be a common interface element, with different impedance matching components (e.g., resistors) of the receiver making up the interface specific elements.

The term interface ASIC (and interface ASIC die) has been used herein to refer to the circuitry that implements many aspects of an interface. However, as best illustrated in FIG. 4B, what is referred to as an interface ASIC may (and likely will) include non-interface circuitry. Such non-interface circuitry may relate, for example, to drive motor control, drive servo control, and the like. Additionally, some aspects of an interface may be implemented outside an ASIC (e.g., in software or firmware).

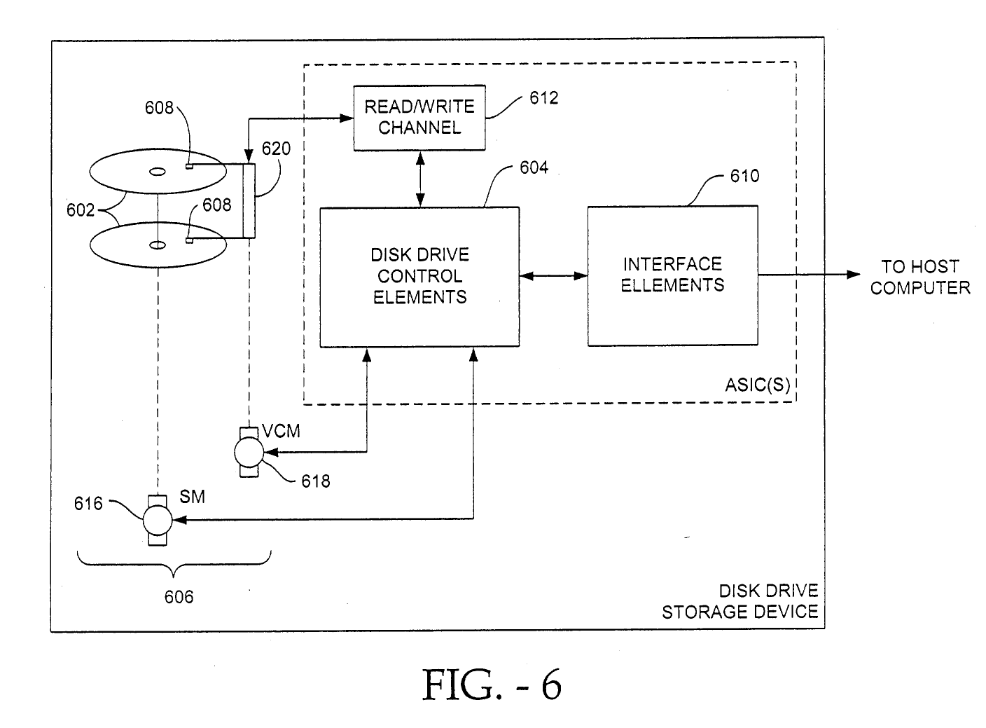

FIG. 6 is a high level diagram of an exemplary disk drive storage device, in which embodiments of the present invention are useful. The disk drive device includes a disk drive controller 604 that operates in conjunction with a head disk assembly (HDA) 606. Disk drive controller 604 performs servo control, signal processing, etc. The disk drive device is also shown as having a read/write channel 612, which includes electronic circuits used in the process of writing and reading information to and from rotatable disks 602.

HDA 606 includes one or more rotatable disks 602 upon which data and servo information can be written to, or read from, using a read/write head 608. Rotatable disks 602 can be, for example, a magnetic medium or an optical medium. Read/write head 608 can include one or more transducers for reading data from and writing data to a magnetic medium, an optical head for exchanging data with an optical medium, or another suitable read/write device. A spindle motor (SM) 616 rotates disks 602 with respect to heads 608. A voice coil motor (VCM) 618 is shown for moving an actuator 620 to position heads 608 on disks 602. VCM 618 and actuator 620 accurately position heads 608 over tracks on disks 602 so that reliable reading and writing of data can be achieved. Other types of motors can alternatively be used, such as a piezo-electric motor or a fluid motor.

Servo information on disks 602 are used by controller 604 to keep heads 608 on track and to assist controller 604 with identifying proper locations on disks 602 where data is written to or read from. Heads 608 act as sensors that detect the position information on disks 602, to provide feedback for proper positioning of heads 608.

Embodiments of the present invention are useful in any storage device that includes a rotatable storage medium, such as in a CD or DVD drive. In a CD or DVD drive, optical sensors are used, and motion control of the sensor is typically performed by a piezo-electric motor or a fluid motor.

Interface elements 610 enable a host computer to communicate with the disk drive device. For example, a host computer can request, via interface elements 610, that data be written to or read from one of disks 602. Interface elements 610 (including elements common to multiple different interfaces and element unique to each of the different multiple interfaces, in accordance with embodiments of the present invention) can be included in the same ASIC as disk control elements 604 and/or read/write channel 612. Alternatively, interface elements 610 can be included in an ASIC devoted (or primarily devoted) to providing interface functionality.

While various embodiments of the present invention have been described above, it should be understood that they have been presented by way of example, and not limitation. It will be apparent to persons skilled in the relevant art that various changes in form and detail can be made therein without departing from the spirit and scope of the invention.

While the present invention has been described with specific relevance to serial ATA, Fibre Channel and Gigabit Ethernet interfaces, the features of the present invention can be used with other types of interfaces (e.g., IEEE 1394, also known as Firewire). More generally, features of the present can be whenever multiple interfaces include common elements.

While the above discussion did not go into details about the number of ports associated with each interface. It is noted that embodiments of the present invention are applicable to serial interfaces that include more than one port, e.g., for redundancy. For example, Fiber Channel drives typically implement two ports. Gigabit Ethernet drives may also implement two ports as well.

The present invention has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the claimed invention.

The breadth and scope of the present invention should not be limited by any of the above-described exemplary embodiments, but should be defined only in accordance with the following claims and their equivalents.

What is claimed:

1. A method for producing a single application specific integrated circuit (ASIC) die capable of supporting multiple interfaces for rotating media storage devices, comprising:
(a) comparing at least two different interfaces for storage devices including rotatable storage medium;
(b) identifying elements that are common to the different interfaces;
(c) identifying elements that are unique to the different interfaces;
(d) incorporating the unique elements for each of the different interfaces, and the common elements, into a single ASIC die; and
(e) implementing switching within the single ASIC die, such that the common elements are used regardless of which one of the different interfaces is being used, and the unique elements are used based on which one of the different interfaces is being used.

2. The method of claim 1, wherein step (e) includes providing switches within the single ASIC die that connect common elements to elements that are unique to one of the different interfaces.

3. The method of claim 2, wherein step (e) further includes selectively switching the switches based upon which one of the different interfaces is being used.

4. The method of claim 1, wherein step (e) includes monitoring a signal to determine which one of the different interfaces is being used.

5. The method of claim 1, wherein step (e) includes accessing a memory to determine which one of the different interfaces is being used.

6. The method of claim 1, wherein step (e) includes determining which one of the different interfaces is being used based on which of a plurality of terminals are electrically connected together.

7. The method of claim 1, wherein each of the different interfaces is a serial interface.

8. The method of claim 1, wherein step (a) comprises comparing at least two of the following different interfaces: serial ATA; Fibre Channel; and Gigabit Ethernet.

9. A method for use with an application specific integrated circuit (ASIC) die capable of supporting at least two different interfaces, each interface for storage devices including rotatable storage medium, the ASIC die including elements that are common to the different interfaces, elements that are unique to each interface, and a plurality of switches, the method comprising:
(a) determining which one of the interfaces is being used; and
(b) controlling the switches such that the common elements are used regardless of which of the interfaces is being used, and the unique elements are used based on which of the interfaces is being used.

10. The method of claim 9, wherein step (a) comprises determining which of the interfaces is being used based on a signal received from a host.

11. The method of claim 9, wherein step (a) comprises monitoring a signal received from a host to determine which one of the interfaces is being used.

12. The method of claim 9, wherein step (a) comprises accessing a memory to determine which one of the interfaces is being used.

13. The method of claim 9, wherein step (a) comprises determining which one of the interfaces is being used based on which of a plurality of terminals are electrically connected together.

14. The method of claim 9, wherein step (a) comprises determining which one of at least two different serial interfaces is a being used, the at least two different serial interfaces comprising at least two of the following different interfaces: serial ATA; Fibre Channel; and Gigabit Ethernet.

15. The method of claim 9, wherein step (a) comprises polling a signal received from a host at a first clock rate to determine which one of the interfaces is being used, the first clock rate being slower than a second clock rate used after one of the interfaces is identified.

16. The method of claim 9, further comprising a step of receiving a signal from a host using same bond pads regardless of which of the interfaces is implemented by the signal, wherein step (a) comprises determining which one of the interfaces is being used based on the signal received from the host.

17. The method of claim 16, wherein step (a) includes monitoring the signal received from the host to determine which one of the interfaces is being used.

18. The method of claim 16, wherein step (a) includes polling the signal received from the host at a first clock rate to determine which one of the interfaces is being used, the first clock rate being slower than a second clock rate used after one of the interfaces is identified.
